(19) United States
(12) Patent Application Publication
(10) Pub. No.: US 2026/0099170 A1
(43) Pub. Date: Apr. 9, 2026

(54) ELECTRONIC DEVICE AND METHOD FOR MANUFACTURING THE SAME

(71) Applicant: SAMSUNG DISPLAY CO., LTD., YONGIN-SI (KR)

(72) Inventors: YEJIN PARK, Yongin-si (KR); JINSEOCK KIM, Yongin-si (KR)

(21) Appl. No.: 19/192,749

(22) Filed: Apr. 29, 2025

(30) Foreign Application Priority Data
Oct. 7, 2024 (KR) 10-2024-0135957

(51) Int. Cl. G06F 1/16

(52) U.S. Cl. CPC G06F 1/1616; G06F 1/1629; G06F 1/1652

(57) ABSTRACT

An electronic device includes a display module comprising a display panel emitting light. The display module has a first non-folding region, a folding region, and a second non-folding region defined therein. The folding region is disposed between the first non-folding region and the second non-folding region. A plate has a through-hole defined therein. The through-hole overlaps the folding region in a first direction. In a first region of the plate, a width of the through-hole in a second direction crossing the first direction varies at a first rate along the first direction. In a second region of the plate, the width of the through-hole in the second direction varies at a second rate along the first direction, the second rate is different from the first rate.

### CROSS-REFERENCE TO RELATED APPLICATIONS

This application claims priority under 35 U.S. C. § 119 to Korean Patent Application No. 10-2024-0135957, filed on Oct. 7, 2024 in the Korean Intellectual Property Office, the disclosure of which is incorporated by reference in its entirety herein.

### 1. TECHNICAL FIELD

The present disclosure relates to an electronic device and a method for manufacturing the same. More particularly, the present disclosure pertains to an electronic device that includes a fiber-reinforced plastic (FRP) plate formed with through-holes having narrow widths and thus increases the impact resistance of the device, as well as a method for manufacturing the same.

### 2. DISCUSSION OF RELATED ART

An FRP plate may be used to provide an electronic device having a flexible display. The FRP plates may be provided with a plurality of through-holes. The through-holes provide an increased impact resistance for the electronic device as the widths of the through-holes decrease. Furthermore, reducing the time required to form the through-holes can reduce the manufacturing costs of the electronic device.

Through-holes in an FRP plate are typically formed using either a blasting process or a laser process. When only the blasting process is employed, the through-holes can be formed in a shorter time, but there are limitations in reducing the widths of the through-holes. On the other hand, when only the laser process is utilized, the widths of the through-holes can be reduced to be relatively smaller, but the process requires a longer time to form the through-holes.

Therefore, there is a challenge to provide reduced widths of the through-holes without requiring extended processing times for forming the through-holes.

### SUMMARY

The present disclosure provides an electronic device that includes a fiber-reinforced plastic (FRP) plate with through-holes formed using both a laser process and a blasting process, thereby increasing the impact resistance of the device, as well as a method for manufacturing such an electronic device.

According to an embodiment of the present disclosure, an electronic device includes a display module comprising a display panel emitting light. The display module has a first non-folding region, a folding region, and a second non-folding region defined therein. The folding region is disposed between the first non-folding region and the second non-folding region. A plate has a through-hole defined therein. The through-hole overlaps the folding region in a first direction. In a first region of the plate, a width of the through-hole in a second direction crossing the first direction varies at a first rate along the first direction. In a second region of the plate, the width of the through-hole in the second direction varies at a second rate along the first direction, the second rate is different from the first rate.

In an embodiment of the present disclosure, the first region may be disposed between the display module and the second region. The first rate may be less than the second rate.

In an embodiment of the present disclosure, the plate may include an upper surface, a first inner surface, a second inner surface, and a lower surface. The first inner surface may extend from the upper surface, and the second inner surface may extend from the first inner surface in a direction intersecting the first inner surface. The lower surface may extend from the second inner surface and opposite to the upper surface. The through-holes may be defined by the first inner surface and the second inner surface.

In an embodiment of the present disclosure, the upper surface may be disposed between the display panel and the lower surface in the first direction. The surface roughness of the upper surface may be less than a surface roughness of the lower surface.

In an embodiment of the present disclosure, the first inner surface, the second inner surface, and the through-holes may each be provided in plural numbers, and each of the through-holes may be formed using both a laser process and a blasting process.

In an embodiment of the present disclosure, the laser process may precede the blasting process.

In an embodiment of the present disclosure, the electronic device may further include a cover member. The cover member may overlap the folding area of the plate. The plate may be positioned between the display module and the cover member in the first direction.

In an embodiment of the present disclosure, the electronic device may further include a window module. The display module may be positioned between the window module and the plate in the first direction.

In an embodiment of the present disclosure, a first length may be a length of the first region measured in the first direction is shorter than a second length of the second region measured in the first direction.

According to an embodiment of the present disclosure, an electronic device may include a display module comprising a display panel emitting light. The display module has a first non-folding region, a folding region, and a second non-folding region defined therein. The folding region is disposed between the first non-folding region and the second non-folding region. A plate has a through-hole overlapping the folding region defined therein. The plate comprises an upper surface. A first inner surface extends from the upper surface. A second inner surface extends from the first inner surface in a direction intersecting the first inner surface. A lower surface extends from the second inner surface and opposite to the upper surface. The through-hole is defined by the first inner surface and the second inner surface.

In an embodiment of the present disclosure, a first angle may be formed between the upper surface and the first inner surface, and a second angle may be formed between a plane encompassing the lower surface and the second inner surface. A magnitude of the first angle may be greater than a magnitude of the second angle.

In an embodiment of the present disclosure, the upper surface may be disposed between the display panel and the lower surface in a first direction. A surface roughness of the upper surface may be less than a surface roughness of the lower surface.

In an embodiment of the present disclosure, the first inner surface, the second inner surface, and the through-holes may each be provided in plurality. Each of the through-holes may be formed using both a laser process and a blasting process.

In an embodiment of the present disclosure, the laser process may be performed prior to the blasting process.

In an embodiment of the present disclosure, the electronic device may further include a cover member. The cover member may be positioned below the plate and may overlap the folding region of the plate in a first direction. The plate may be disposed between the display module and the cover member in the first direction.

In an embodiment of the present disclosure, the electronic device may further include a window module and the display module is disposed between the window module and the plate.

In an embodiment of the present disclosure, the width of the through-hole may vary at a first rate over a first length in a thickness direction of the plate, and the width of the through-holes may vary at a second rate, different from the first rate, over a second length in the thickness direction of the plate.

According to an embodiment of the present disclosure, a method for manufacturing an electronic device includes preparing a plate comprising an upper surface and a lower surface opposite to the upper surface. A laser process is performed in which a plurality of through-holes are formed in the plate through the laser process and a projection of each of the plurality of through-holes onto a plane including one of the upper surface and the lower surface has a first area. A blasting process is performed in which the plate is processed through the blasting process and a projection of each of the plurality of through-holes onto a plane including one of the upper surface and the lower surface has a second area larger than the first area. A display panel has a first non-folding region, a folding region, and a second non-folding region defined therein. The display panel and the plate are aligned. The plurality of through-holes overlap the folding region when aligned. The display panel is attached to the plate.

In an embodiment of the present disclosure, the upper surface of the plate may be disposed between the lower surface and the display panel. The surface roughness of the upper surface may be less than that of the lower surface. In the performing of the laser process, the plurality of through-holes may be formed in a direction from the lower surface towards the upper surface.

In an embodiment of the present disclosure, in the performing of the blasting process the plate may further include a first inner surface and a second inner surface defining the plurality of through-holes. The first inner surface may extend from the upper surface, and the second inner surface may extend from the first inner surface towards the lower surface in a direction intersecting the first inner surface.

According to an embodiment of the present disclosure, it is possible to provide an electronic device, as well as a method for manufacturing such an electronic device, with an increased impact resistance, owing to including an FRP plate with through-holes formed using both a laser process and a blasting process.

### BRIEF DESCRIPTION OF THE DRAWINGS

These and/or other features will become apparent and more readily appreciated from the following description of non-limiting embodiments, taken in conjunction with the accompanying drawings in which:

FIG. 1A illustrates an unfolded state of an electronic device according to an embodiment of the present disclosure;

FIG. 1B illustrates a state when the electronic device shown in FIG. 1A is being folded according to an embodiment of the present disclosure;

FIG. 1C illustrates a state when the electronic device shown in FIG. 1A is folded according to an embodiment of the present disclosure;

FIG. 2A is an exploded perspective view of an electronic device according to an embodiment of the present disclosure;

FIG. 2B is a cross-sectional view of the electronic device taken along line I-I′ in FIG. 1A according to an embodiment of the present disclosure;

FIG. 3A is a perspective view of the plate shown in FIG. 2B according to an embodiment of the present disclosure;

FIG. 3B is a cross-sectional view of the plate shown in FIG. 3A, taken along a predetermined plane according to an embodiment of the present disclosure;

FIGS. 3C through 3F illustrate effects observed when a through-hole is formed using both a laser process and a blasting process according to embodiments of the present disclosure;

FIGS. 4A, 4B, 4C, and 4D are plan views of a portion of the plate shown in FIG. 2B according to embodiments of the present disclosure;

FIG. 5 is an flow diagram illustrating a method for manufacturing an electronic device according to an embodiment of the present disclosure;

FIG. 6A illustrates an example of performing the step of preparing a plate according to an embodiment of the present disclosure;

FIG. 6B illustrates an example of performing the step of performing a laser process according to an embodiment of the present disclosure;

FIG. 6C illustrates an example of performing the step of performing a blasting process according to an embodiment of the present disclosure;

FIG. 6D illustrates an example of performing the step of preparing a display panel according to an embodiment of the present disclosure;

FIG. 6E illustrates an example of performing the step of aligning through-holes according to an embodiment of the present disclosure;

FIG. 6F illustrates an example of performing the step of attaching the display panel according to an embodiment of the present disclosure;

FIG. 7A illustrates a block diagram of an exemplary electronic device according to an embodiment of the present disclosure; and

FIG. 7B illustrates various electronic devices according to embodiments of the present disclosure.

### DETAILED DESCRIPTION OF EMBODIMENTS

References will now be made in detail to certain embodiments, of which examples are illustrated in the accompanying drawings, where like reference numerals refer to like elements throughout. Embodiments of the present disclosure may have a variety of forms and permutations and shall not be limited to the described embodiments. Rather, embodiments of the present disclosure shall be construed to encompass all forms, permutations, equivalents and substitutes covered by the technical ideas and scope of the present disclosure. Accordingly, non-limiting embodiments are merely described below, by referring to the figures, to explain features of the present disclosure.

Like or identical reference numerals refer to like or identical elements. Moreover, in the accompanying drawings, the thicknesses, ratios, and dimensions of the elements may not be to exact scale and may have been exaggerated for the benefit of effective explanation of the technical features associated with these elements. As such, the present disclosure shall not necessarily be restricted to the thicknesses, ratios, dimensions, etc. illustrated in the drawings. The term “and/or” shall include the combination of a plurality of listed items or any of the plurality of listed items that can be defined by relevant elements.

An expression such as “comprising” or “including” is intended to designate a characteristic, a number, a step, an operation, an element, a part or combinations thereof, and shall not be construed to preclude any possibility of presence or addition of one or more other characteristics, numbers, steps, operations, elements, parts or combinations thereof.

The present disclosure concerns an electronic device includes a foldable display panel having a plate supporting the display panel. The plate includes through-holes overlapping a folding region of the display panel. The through-holes have a width that is narrower in a first area and larger in a second area. The first area is between the display panel and the second area. The first area may be formed by a laser process and a blasting process. The second area may be formed primarily by the blasting process. A width of the first area may vary at a rate in a first direction from a top surface of the plate to the second area that is less than the rate that the second area may vary from a portion adjacent to the first area to a bottom surface of the plate. An angle formed between the upper surface and a first inner surface in the first area may be greater than angle formed between a second inner surface in the second area and a bottom surface. The relatively narrow width of the through-hole closer to the display panel increases the impact resistance of the electronic device. The surface roughness of the upper surface of the plate may be less than the surface roughness of the lower surface to provide increased display quality.

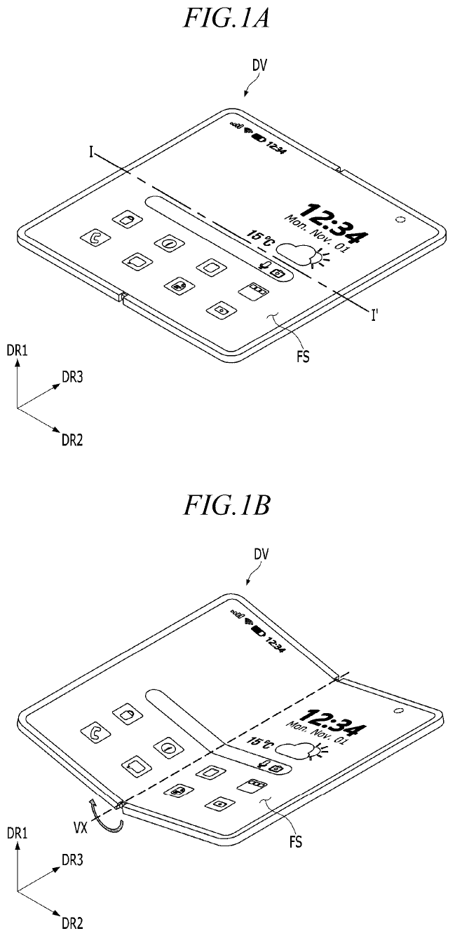

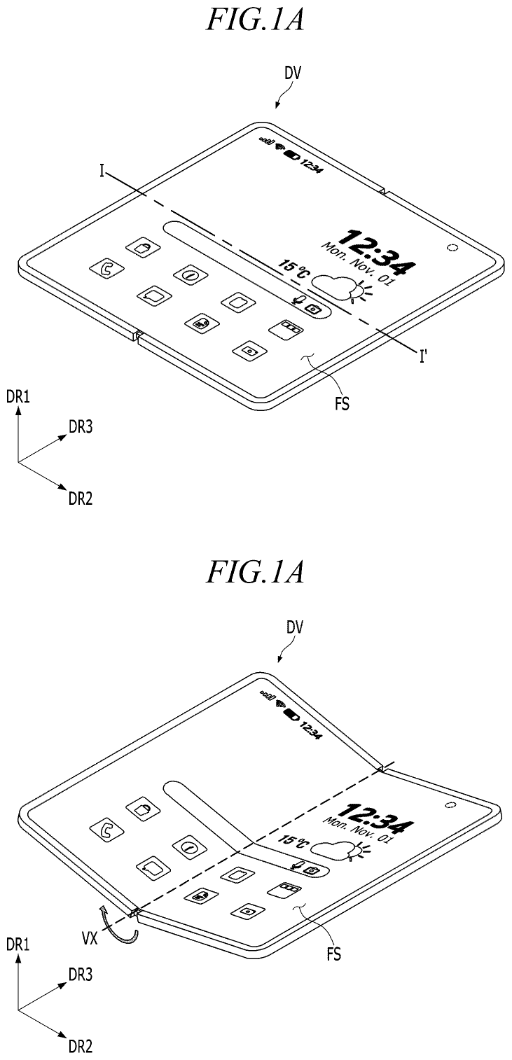

FIG. 1A illustrates an unfolded state of an electronic device DV according to an embodiment of the present disclosure, and FIG. 1B illustrates a state when the electronic device DV shown in FIG. 1A is being folded, while FIG. 1C illustrates a state when the electronic device DV shown in FIG. 1a is folded.

A first direction DR1 may correspond to the thickness direction of the electronic device DV. A second direction DR2 may be perpendicular to the first direction DR1. A third direction DR3 may be perpendicular to both the first direction DR1 and the second direction DR2. However, embodiments of the present disclosure are not necessarily limited thereto and the first to third directions DR1, DR2, DR3 may cross each other at various different angles.

Referring to FIG. 1A, the electronic device DV may be configured to display images through a display surface FS that extends in a plane parallel to the second direction DR2 and the third direction DR3. The electronic device DV may include a flexible display. Referring to FIGS. 1B and 1C, the electronic device DV may be folded along a virtual axis VX that extends in a direction parallel to the third direction DR3.

In the present specification, the term “in-folding” refers to the electronic device DV being folded such that the display surface FS faces itself in a folded state and is not exposed externally. Conversely, “out-folding” refers to the electronic device DV being folded such that the display surface FS is exposed externally when in a folded state. While FIGS. 1B and 1C depict the electronic device DV undergoing in-folding, embodiments of the present disclosure are not necessarily limited thereto. In an embodiment of the present disclosure, the electronic device DV may perform only one of in-folding and out-folding. In an embodiment of the present disclosure, the electronic device DV may perform both in-folding and out-folding.

Although the electronic device DV is depicted as a smartphone in FIGS. 1A through 1C, embodiments of the present disclosure are not necessarily limited thereto. In some embodiments, the electronic device DV may include at least one of a large flexible display and a medium-to small-sized flexible display. For example, in an embodiment large flexible displays may include those used in televisions, monitors, and billboards. Medium-to small-sized flexible displays may include those used in tablets, built-in displays in home appliances, smartwatches, and smartphones. However, embodiments of the present disclosure are not necessarily limited thereto and the electronic device DV may include various other small, medium or large sized devices.

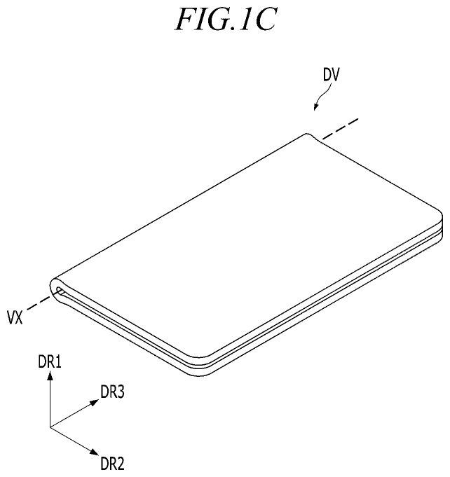

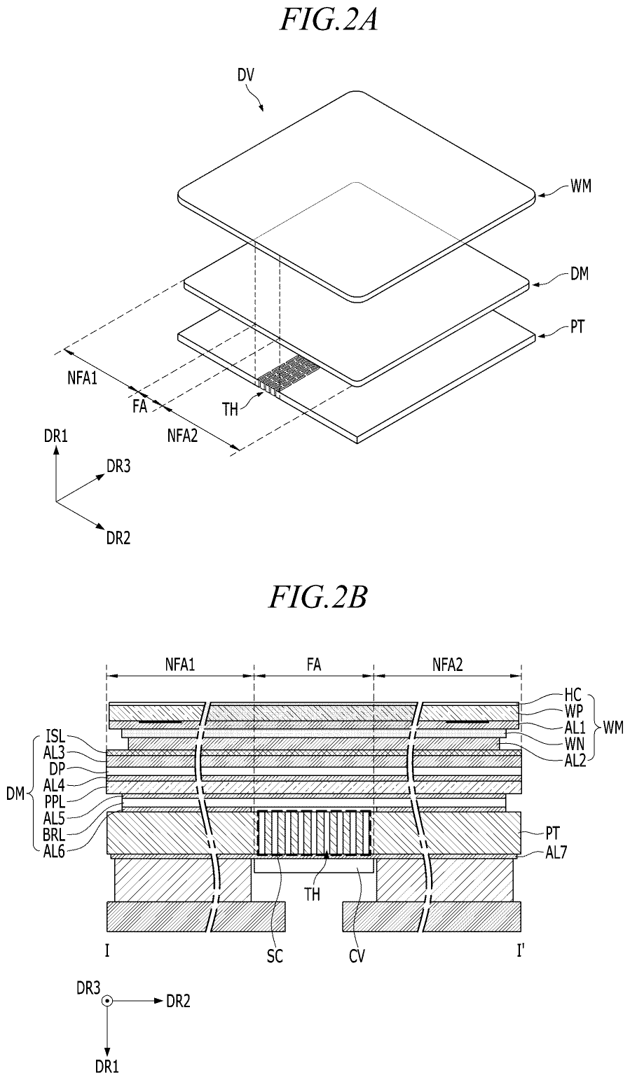

FIG. 2A is an exploded perspective view of an electronic device DV according to an embodiment of the present disclosure, and FIG. 2B is a cross-sectional view of the electronic device DV taken along line I-I′ in FIG. 1A.

Referring to FIGS. 2A and 2B, the electronic device DV may include a window module WM, a display module DM, a plate PT, and a cover member CV.

The window module WM may be disposed above the display module DM (e.g., in the first direction DR1) and may define the external appearance of the electronic device DV and protect the display module DM. The window module WM may include a flexible material. Accordingly, when the electronic device DV is folded along the virtual axis VX, the window module WM may also bend.

In an embodiment, the window module WM may include a hard coating layer HC, a window protection layer WP, a first adhesive layer AL1, a window WN, and a second adhesive layer AL2. The window protection layer WP may be disposed below (e.g., directly below in the hard coating layer HC and may include a flexible plastic material. For example, in an embodiment the window protection layer WP may include at least one of polyimide (PI) and polyethylene terephthalate (PET).

The first adhesive layer AL1 may be disposed between (e.g., directly therebetween in the first direction DR1) the window protection layer WP and the window WN to bond the window protection layer WP with the window WN. The window WN may include a transparent material. Accordingly, light emitted from the display module DM can pass through the window WN. For example, the window WN may include at least one of a glass substrate and a synthetic resin film. In an embodiment, the synthetic resin film may include at least one of a polyimide (PI) film and a polyethylene terephthalate (PET) film.

In an embodiment of the present disclosure, the window WN may include multiple synthetic resin films bonded together using an adhesive. In an embodiment of the present disclosure, the window WN may include a glass substrate and at least one synthetic resin film bonded together using an adhesive.

In an embodiment, the second adhesive layer AL2 may be disposed between (e.g.,. directly therebetween in the first direction DR1) the window WN and the display module DM to bond the window WN with the display module DM. However, embodiments of the present disclosure are not necessarily limited thereto. For example, in an embodiment, the window module WM may be omitted.

In an embodiment, the display module DM may include an impact absorption layer ISL, a third adhesive layer AL3, a display panel DP, a fourth adhesive layer AL4, a panel protection layer PPL, a fifth adhesive layer AL5, a barrier layer BRL, and a sixth adhesive layer AL6.

The impact absorption layer ISL may be disposed above the display panel DP and may be configured to absorb shocks transmitted from above the display panel DP to protect the display panel DP. In an embodiment, the impact absorption layer ISL may include a flexible plastic material, such as a synthetic resin film. The synthetic resin film may include at least one of a PI film and a PET film.

In an embodiment, the third adhesive layer AL3 may be disposed between (e.g., directly therebetween in the first direction DR1) the impact absorption layer ISL and the display panel DP to bond the impact absorption layer ISL with the display panel DP. The display panel DP may be configured to emit light. In an embodiment, the display panel DP may have a folding region FA, a first non-folding region NFA1, and a second non-folding region NFA2 defined therein. The folding region FA may overlap the virtual axis VX shown in FIG. 1B. The folding region FA may include a flexible material. Accordingly, the folding region FA can be bent when the electronic device DV folds along the virtual axis VX. The folding region FA may be disposed between the first non-folding region NFA1 and the second non-folding region NFA2 (e.g., in the second direction DR2).

The display panel DP may include a plurality of pixels, each of which may include a light-emitting diode and a pixel circuit configured to control the current flowing through the light-emitting diode. For example, in an embodiment the display panel DP may be any one of an organic light-emitting diode display panel, a quantum dot light-emitting diode display panel, a micro-LED display panel, a liquid crystal display panel, an electrophoretic display panel, and an electrowetting display panel. The light-emitting layer of the organic light-emitting diode display panel may include an organic light-emitting material. Inorganic light-emitting diode display panels may include quantum dot light-emitting diode display panels and micro light-emitting diode display panels based on inorganic materials.

In an embodiment, the fourth adhesive layer AL4 may be disposed between (e.g., directly therebetween in the first direction DR1) the display panel DP and the panel protection layer PPL to bond the display panel DP with the panel protection layer PPL. The panel protection layer PPL may be disposed below the display panel DP and may be configured to absorb shocks transmitted from below the display panel DP to protect the display panel DP. In an embodiment, the panel protection layer PPL may include a flexible plastic material, such as polyethylene terephthalate (PET).

In an embodiment, the fifth adhesive layer AL5 may be disposed between (e.g., directly therebetween in the first direction DR1) the panel protection layer PPL and the barrier layer BRL to bond the panel protection layer PPL with the barrier layer BRL. The barrier layer BRL may be disposed below the panel protection layer PPL and may be configured to prevent deformation of the display panel DP caused by compression. For example, in an embodiment the barrier layer BRL may include at least one of polyimide (PI) and polyethylene terephthalate (PET).

In an embodiment, the sixth adhesive layer AL6 may be disposed between (e.g., directly therebetween) the barrier layer BRL and the plate PT to bond the barrier layer BRL with the plate PT. However, embodiments of the present disclosure are not necessarily limited thereto. For example, in an embodiment of the present disclosure, at least one of the impact absorption layer ISL, the third adhesive layer AL3, the fourth adhesive layer AL4, the panel protection layer PPL, the fifth adhesive layer AL5, the barrier layer BRL, and the sixth adhesive layer AL6 may be omitted.

The plate PT may be disposed below the display panel DP and may be configured to support the display panel DP. The plate PT may be disposed between the display panel DP and the cover member CV (e.g., in the first direction DR1). The plate PT may have through-holes TH defined therein. The through-holes TH may overlap the folding region FA in a predetermined direction, such as the first direction DR1.

The cover member CV may be disposed below the plate PT and may be configured to prevent foreign substances from entering the display module DM through the through-holes TH. The cover member CV may overlap the folding region FA of the plate PT. For example, in an embodiment the cover member CV may include at least one of a foam material and a sponge. The foam material may include at least one of polyurethane foam and thermoplastic polyurethane foam.

In an embodiment of the present disclosure, the electronic device DV may further include a seventh adhesive layer AL7. The seventh adhesive layer AL7 may be disposed between (e.g., directly therebetween in the first direction DR1) the plate PT and the cover member CV to bond the plate PT with the cover member CV.

Although it is depicted in FIG. 2B that the electronic device DV includes the first through seventh adhesive layers AL1-AL7, embodiments of the present disclosure are not necessarily limited thereto. For example, in some embodiments, another adhesive layer may be added, or at least one of the first through seventh adhesive layers AL1-AL7 may be omitted.

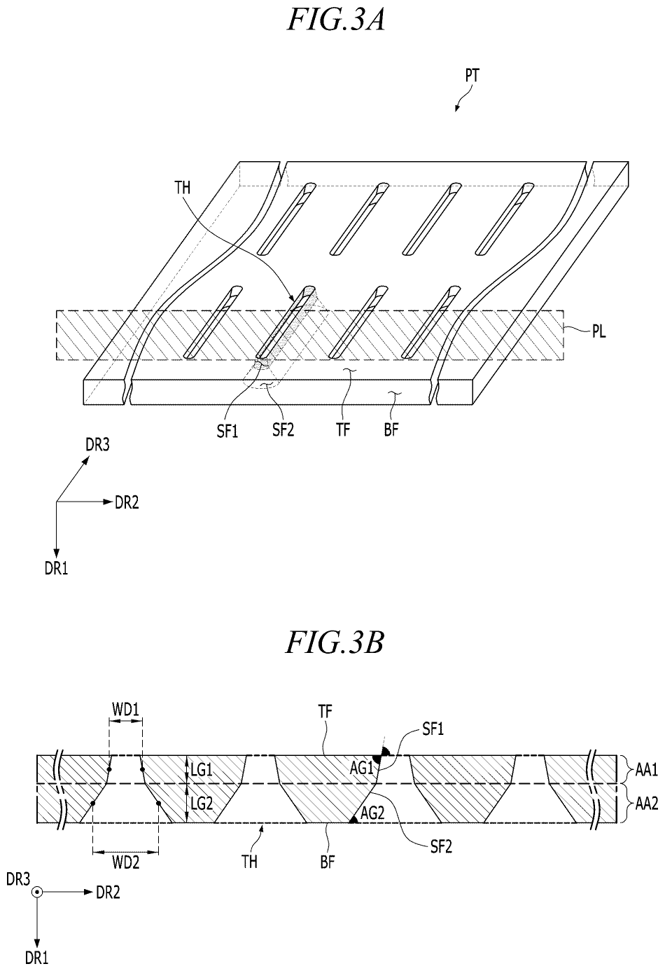

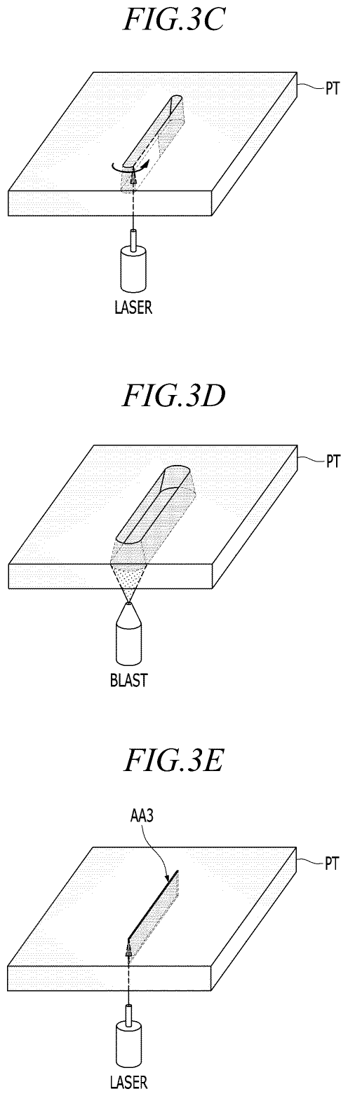

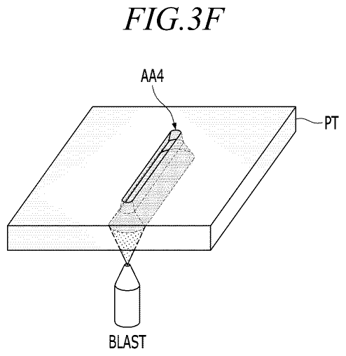

FIG. 3A illustrates a perspective view of the plate PT shown in FIG. 2B. FIG. 3B illustrates a cross-sectional view of the plate PT shown in FIG. 3A, taken along a predetermined plane PL.

Referring to FIGS. 3A and 3B, the plate PT according to an embodiment of the present disclosure may include an upper surface TF, a first inner surface SF1, a second inner surface SF2, and a lower surface BF.

The upper surface TF may face opposite both the display panel DP and the lower surface BF and may be disposed between the display panel DP and the lower surface BF (e.g., in the first direction DR1). The first inner surface SF1 may extend from the upper surface TF. The second inner surface SF2 may extend from the first inner surface SF1 in a direction intersecting the first inner surface SF1. The first inner surface SF1 and the second inner surface SF2 may define through-holes TH. In an embodiment of the present disclosure, the through-holes TH may be provided in plurality.

Although FIG. 3A shows a single first inner surface SF1 and a single second inner surface SF2, embodiments of the present disclosure are not necessarily limited thereto. In an embodiment, the first inner surface SF1 and the second inner surface SF2 may be provided in plural numbers.

The lower surface BF may extend from the second inner surface SF2. In an embodiment, the surface roughness of the lower surface BF may be greater than that of the upper surface TF. In the present specification, surface roughness refers to the degree of roughness of the surface. A surface with greater surface roughness is more likely to be visible. Of the upper surface TF and the lower surface BF, the upper surface TF is the surface visible to the user. Therefore, reducing the surface roughness of the upper surface TF relative to the lower surface BF may increase the quality of the images displayed by the electronic device DV.

Reducing the surface roughness of the plate PT also increases manufacturing costs. Thus, selectively processing the upper surface TF, which is visible to the user, to have smaller surface roughness than the lower surface BF can achieve the desired effects while reducing manufacturing costs.

Referring to FIG. 3A, the predetermined plane PL may be defined by the first direction DR1 and the second direction DR2. In an embodiment, the first direction DR1 may be perpendicular to the folding region FA, and the second direction DR2 may be perpendicular to the first direction DR1.

Referring to FIG. 3B, the cross-section of the plate PT cut by the predetermined plane PL may include a first region AA1 and a second region AA2. The second region AA2 may be a region that does not overlap the first region AA1 in the second direction DR2. For example, the first region AA1 and the second region AA2 may be arranged in the first direction DR1.

A first width WD1 may refer to the width of the through-hole TH measured in the second direction DR2 within the first region AA1, and a second width WD2 may refer to the width of the through-hole TH measured in the second direction DR2 within the second region AA2. In an embodiment, the first region AA1 may include areas of the plate PT processed using both a laser process and a blasting process, while the second region AA2 may include areas primarily processed using the blasting process. For example, a large portion of the second width WD2 of the second region AA2 may be due to the performance of the blasting process.

A first length LG1 may refer to the length of the first region AA1 measured in the first direction DR1 and may correspond to the length of the area of the through-hole TH processed using both the laser process and the blasting process. A second length LG2 may refer to the length of the second region AA2 measured in the first direction DR1 and may correspond to the length of the area of the through-hole TH primarily processed using the blasting process.

In an embodiment of the present disclosure, some portions of the cross-section of the plate PT may be classified as the first region AA1, while the remaining portions may be classified as the second region AA2. In an embodiment, the first length LG1 may be shorter than the second length LG2. For example, the length of the area of the through-hole TH processed using both the laser and blasting processes may be shorter than the length of the area primarily processed using the blasting process.

In an embodiment of the present disclosure, the first width WD1 may vary (e.g., changes) at a first rate along the first direction DR1, and the second width WD2 may vary at a second rate, which is different from the first rate, along the first direction DR1. For example, the widths WD1, WD2 of the through-holes in the areas processed using the laser and blasting processes and those primarily processed using the blasting process, respectively, may vary (e.g., change) at different rates.

In an embodiment of the present disclosure, a width WD of the through-hole TH may vary at a first rate over the first length LG1 along the thickness direction of the plate PT and at a second rate over the second length LG2. The second rate may differ from the first rate. In an embodiment, the thickness direction of the plate PT may be parallel to the first direction DR1.

In an embodiment of the present disclosure, the first rate may be less than the second rate. For example, the width WD1 of the through-hole TH in the area primarily processed using the blasting process may vary more abruptly than the width WD2 in the area processed using both the laser and blasting processes. For example, as shown in FIG. 3B the width WD1 of the through-hole TH in the first region AA1 may increase at a relatively gradual rate along the first direction DR1 from the upper surface TF to the end of the first region AA1 adjacent to the second region AA2. The width WD2 of the through hole TH in the second region AA2 may increase at a relatively rapid rate along the first direction DR1 from the surface of the second region AA2 adjacent to the first region AA1 to the lower surface BF.

In an embodiment of the present disclosure, a first angle AG1 may be formed between the upper surface TF and the first inner surface SF1, and a second angle AG2 may be formed between a plane including the lower surface BF and the second inner surface SF2. The first angle AG1 may be larger than the second angle AG2. For example, the slope of the through-hole TH in the area primarily processed using the blasting process may be gentler than the slope in the area processed using both the laser and blasting processes. In an embodiment, the first angle AG1 may be in a range from about 80 degrees to about 90 degrees, and the second angle AG2 may be in a range less than or equal to about 70 degrees. However, these angles are examples, and the values of the first and second angles AG1, AG2 are not necessarily limited to these examples. For example, the first angle AG1 and the second angle AG2 may be adjusted as needed.

The narrower the width of the through-hole TH relatively closer to the display panel DP, the greater the impact resistance of the electronic device DV. In an embodiment, the first region AA1 may be disposed between the display panel DP and the second region AA2 (e.g., in the first direction DR1), and the first width WD1 may be narrower than the second width WD2. Thus, by forming through-holes TH with the first width WD1 narrower than the second width WD2 in the present disclosure, the impact resistance of the electronic device DV can be increased. In an embodiment, the minimum value of the first width WD1, measured in the second direction DR2 within the first region AA1, may be in a range from about 0.07 μm to about 0.08 μm. However, these values are examples, and the minimum value of the first width WD1 is not necessarily limited to these examples. For example, the minimum value of the first width WD1 may be adjusted as needed.

In the present specification, the shape of the through-hole refers to the shape projected onto a plane including either the upper surface TF or the lower surface BF. An elliptical through-hole refers to a through-hole having a projection onto the aforementioned plane that is elliptical, while a linear through-hole refers to a through-hole having a projection onto the aforementioned plane that is linear. The impact resistance of the electronic device DV may be further increased with elliptical through-holes compared to linear through-holes.

FIGS. 3C through 3F illustrate effects observed when a through-hole TH is formed using both a laser process and a blasting process.

FIG. 3C illustrates an example where a through-hole TH is formed in the plate PT using only a laser process. Due to the high collimation of lasers, the laser process is useful for forming relatively narrow linear through-holes. However, as shown in FIG. 3C, when forming an elliptical through-hole in the plate PT using only the laser process, the entire region of the plate PT corresponding to the through-hole TH must be processed by the laser, which can result in an excessively long processing time.

FIG. 3D illustrates an example where a through-hole TH is formed in the plate PT using only a blasting process. The blasting process enables rapid processing over a wide area and thus may be useful for forming elliptical through-holes in the plate PT. However, as shown in FIG. 3D, forming a narrow through-hole using only the blasting process may be difficult.

In an embodiment of the present disclosure, each of the plurality of through-holes TH may be formed using both the blasting process and the laser process. The laser process may be performed prior to the blasting process. Thus, narrow elliptical through-holes can be formed in the plate PT in a short amount of time.

Hereinafter, the process of forming through-holes TH using the laser process and the blasting process according to an embodiment of the present disclosure is described with reference to FIGS. 3E and 3F.

FIG. 3E illustrates an example where a linear through-hole is formed in the plate PT through the laser process. FIG. 3F illustrates an example where an elliptical through-hole is formed in the plate PT through a subsequent blasting process after the laser process shown in FIG. 3E.

Referring to FIG. 3E, by use of the laser process, a narrow region AA3 of the plate PT may be processed to form a linear through-hole in the plate PT. Referring to FIG. 3F, by use of the blasting process, a wider region AA4 of the plate PT adjacent to the linear through-hole may be rapidly processed to form an elliptical through-hole in the plate PT.

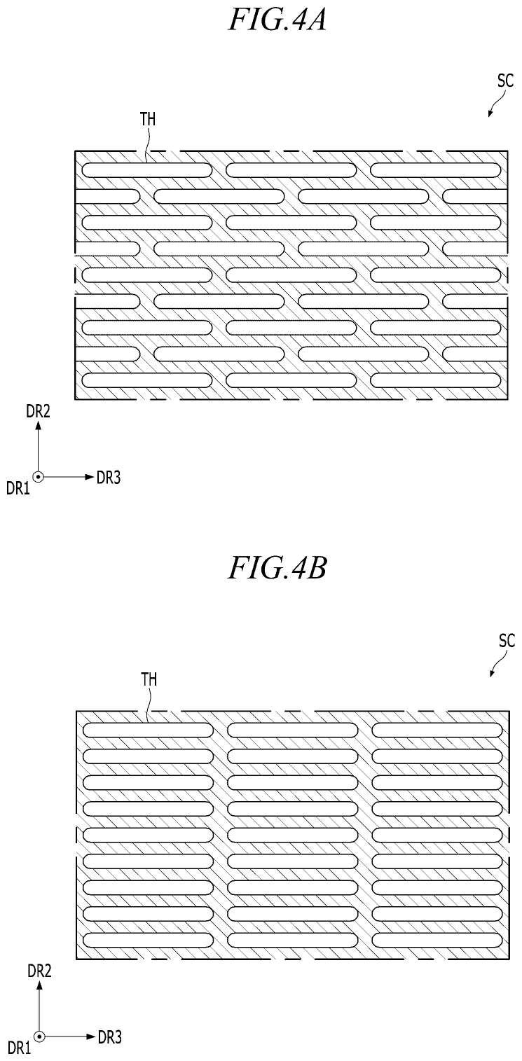

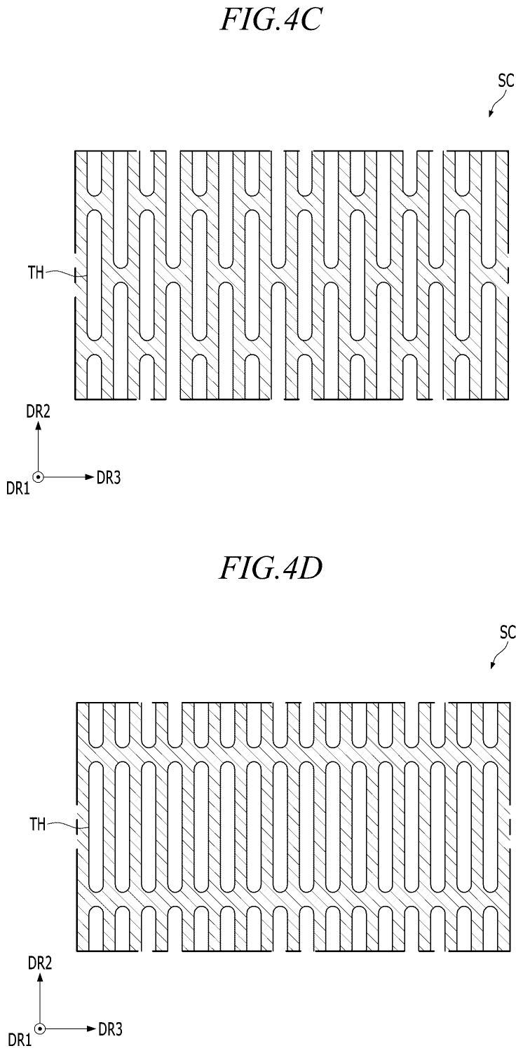

FIGS. 4A, 4B, 4C, and 4D respectively illustrate plan views of a portion SC of the plate PT shown in FIG. 2B.

Referring to FIGS. 4A and 4B, in some embodiments each of the plurality of through-holes TH may pass through (e.g., extend fully through) the plate PT in the first direction DR1 and may have a shape extending longer in the third direction DR3, which is parallel to the virtual axis VX.

Referring to FIGS. 4C and 4D, each of the plurality of through-holes TH may pass through the plate PT in the first direction DR1 and may have a shape extending longer in the second direction DR2, which is perpendicular to the virtual axis VX.

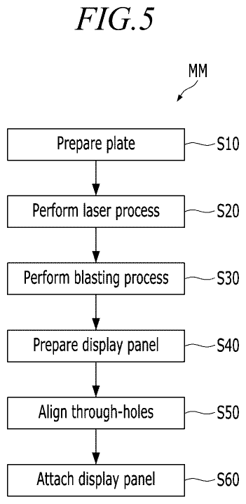

FIG. 5 illustrates a flow diagram of a method MM for manufacturing an electronic device according to an embodiment of the present disclosure.

Referring to FIG. 5, the method MM for manufacturing an electronic device according to an embodiment of the present disclosure may include preparing a plate in block S10, performing a laser process in block S20, performing a blasting process in block S30, preparing a display panel in block S40, aligning through-holes in block s50, and attaching the display panel in block s60.

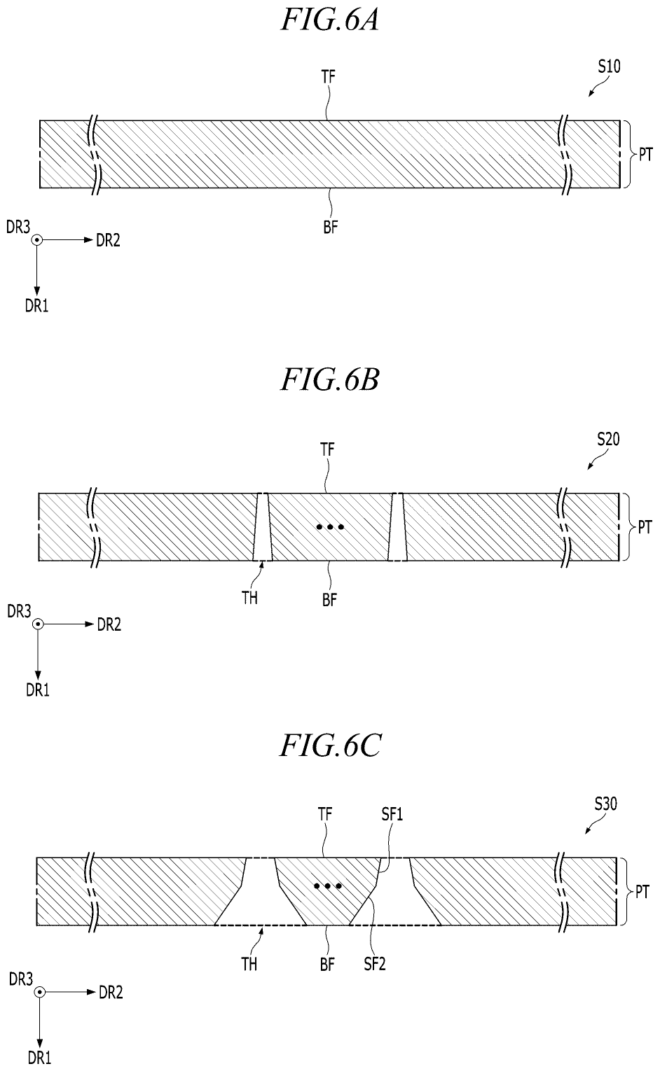

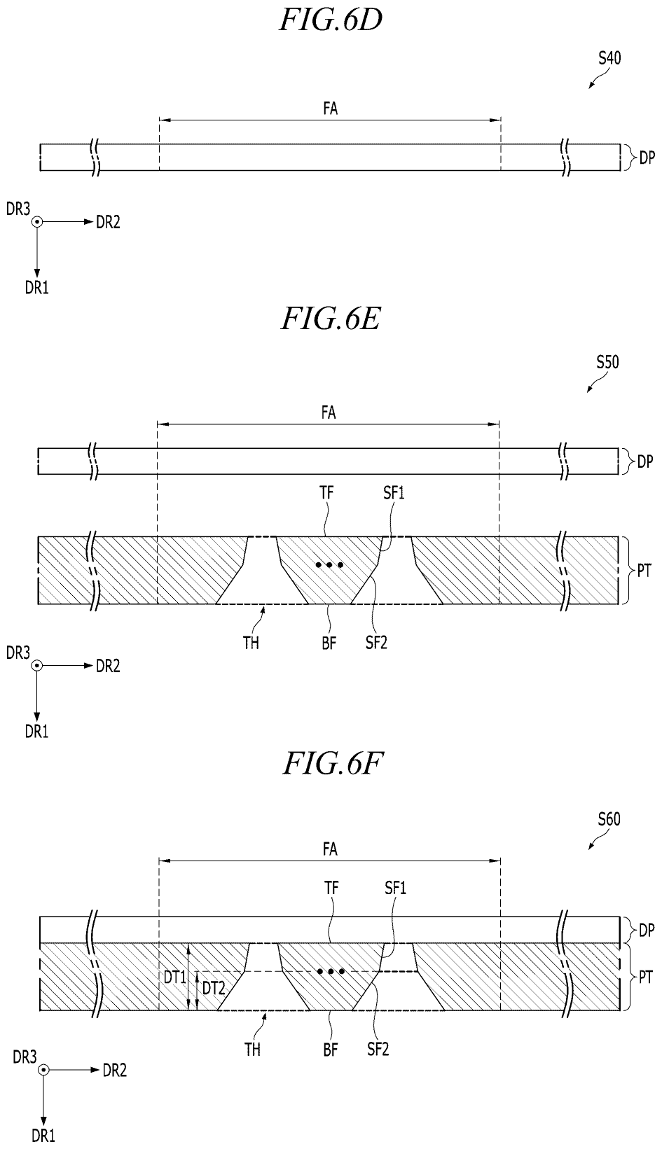

FIG. 6A illustrates an example of performing the step of preparing a plate in block S10. Referring to FIG. 6A, in the step of preparing a plate in block S10, a plate PT may be prepared. The plate PT may include an upper surface TF and a lower surface BF. The lower surface BF may face opposite the upper surface TF (e.g., in the first direction DR1).

FIG. 6B illustrates an example of the step of performing a laser process in block S20. Referring to FIGS. 3E and 6B, in the step of performing a laser process in block S20, a plurality of through-holes TH may be formed in the plate PT through a laser process. The shape of each of the plurality of through-holes TH projected onto a plane including one of the upper surface TF and the lower surface BF may have a first area. For example, the shape of each of the plurality of through-holes TH in a plane that one of the upper surface TF and the lower surface BF may extend in, such as the second and third directions DR2, DR3, may have a first area. In the step of performing a laser process in block S20 according to an embodiment of the present disclosure, the shape of each of the plurality of through-holes TH projected onto (e.g., in a) a plane including one of the upper surface TF and the lower surface BF may be linear. For example, in the step of performing a laser process in block S20, a plurality of through-holes TH may be formed in the plate PT, and each of the plurality of through-holes TH may be a linear through-hole. In an embodiment, in the step of performing the laser process in block S20, the plurality of through-holes TH may be formed from the lower surface BF towards the upper surface TF.

FIG. 6C illustrates an example of the step of performing a blasting process in block S30. Referring to FIGS. 3F and 6C, in the step of performing a blasting process in block S30, the plate PT may be processed such that the projection of each of the plurality of through-holes TH onto a plane including one of the upper surface TF and the lower surface BF has a second area larger than the first area. In the step of performing a blasting process in block S30 according to an embodiment of the present disclosure, the plate PT may be processed such that the projection of each of the through-holes TH onto a plane including one of the upper surface TF and the lower surface BF becomes elliptical. For example, in the step of performing a blasting process in block S30, each of the plurality of through-holes TH may be transformed from a linear through-hole to an elliptical through-hole.

The narrower the width of the portion of the through-hole TH adjacent to the display panel DP, and the closer the shape of the through-hole TH to an ellipse, the greater the impact resistance of the electronic device DV. In the step of performing a blasting process in block S30 according to an embodiment of the present disclosure, after the blasting process is performed in block S30 the plate PT may further include a first inner surface SF1 and a second inner surface SF2 defining each of the plurality of through-holes TH. The first inner surface SF1 may extend from the upper surface TF to the second inner surface SF2, and the second inner surface SF2 may extend from the first inner surface SF1 in a direction intersecting the first inner surface SF1, towards the lower surface BF.

FIG. 6D illustrates an example of the step of preparing a display panel in block S40. Referring to FIG. 6D, in the step of preparing a display panel in block S40, a display panel DP may be prepared. A flexible folding region FA may be defined within the display panel DP.

FIG. 6E illustrates an example of the step of aligning through-holes in block S50. Referring to FIG. 6E, in the step of aligning through-holes in block S50, the display panel DP and the plate PT may be aligned such that the plurality of through-holes TH overlap the folding region FA.

FIG. 6F illustrates an example of the step of attaching the display panel in block S60. Referring to FIG. 6F, in the step of attaching the display panel in block S60, the display panel DP may be attached to the plate PT. In an embodiment, the upper surface TF of the plate PT may be disposed between the lower surface BF of the plate PT and the display panel DP (e.g., in the first direction DR1). The surface roughness of the upper surface TF of the plate PT may be less than the surface roughness of the lower surface BF. Reducing the surface roughness of the upper surface TF, which is visible to the user, compared to the lower surface BF may increase the quality of the images displayed by the electronic device DV.

Referring to FIG. 6F, the first direction DR1 may be perpendicular to the folding region FA. A first distance DT1 may refer to the combined length of the first and second inner surfaces SF1, SF2 measured along the first direction DR1, and a second distance DT2 may refer to the length of the second inner surface SF2 measured along the first direction DR1. The first distance DT1 may represent the total length of the through-hole TH formed using both the laser and blasting processes, and the second distance DT2 may represent the length of the portion of the through-hole TH primarily formed using the blasting process. The ratio of the second distance DT2 to the first distance DT1 may represent the proportion of the through-hole TH formed primarily using the blasting process. For example, dividing the second distance DT2 by the first distance DT1 yields the proportion of the through-hole TH formed primarily by the blasting process.

In an embodiment of the present disclosure, the ratio of the second distance DT2 to the first distance DT1 may be in a range of about 0.5 to about 1.0. For example, the value obtained by dividing the second distance DT2 by the first distance DT1 may be in a range of about 0.5 to about 1.0. This means that the proportion of the through-hole TH primarily formed by the blasting process within the entire through-hole TH may be greater than the proportion formed by the laser and blasting processes combined. The larger the proportion of the through-hole TH formed primarily by the blasting process, the shorter the time required to form the through-hole TH. In an embodiment of the present disclosure, the value obtained by dividing the second distance DT2 by the first distance DT1 may be in a range from about ⅔ to about ¾. However, embodiments of the present disclosure are not necessarily limited to these specific values, and the ratio of the second distance DT2 to the first distance DT1 may vary.

Other components described with reference to FIGS. 1A through 4D are omitted for brevity, as they are substantially the same.

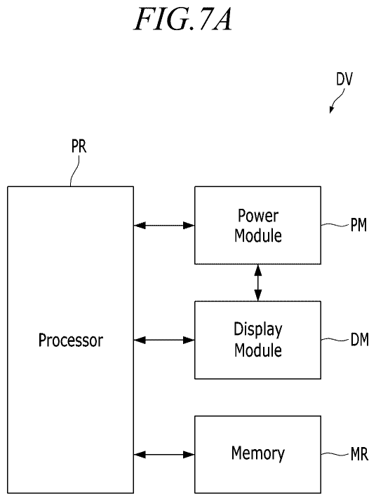

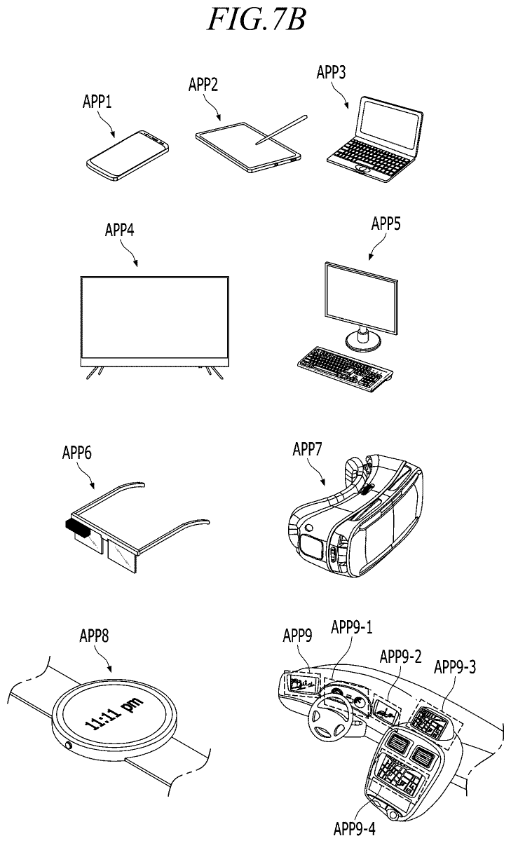

FIG. 7A illustrates a block diagram of an electronic device DV according to an embodiment of the present disclosure.

Referring to FIG. 7A, the electronic device DV according to an embodiment may include a display module DM, a processor PR, a memory MR, and a power module PM. In an embodiment, the processor PR may include at least one of a central processing unit (CPU), an application processor (AP), a graphic processing unit (GPU), a communication processor (CP), an image signal processor (ISP), and a controller.

The memory MR may have data and information necessary for the operations of the processor PR or the display module DM stored therein. When the processor PR executes an application stored in the memory MR, image data signals and/or input control signals may be transmitted to the display module DM, which may then process the received signals and output visual information through the display screen.

In an embodiment, the power module PM may include a power supply module, such as a power adapter or a battery device, and a power conversion module configured to convert the power supplied by the power supply module to generate the power necessary for the operation of the electronic device DV.

At least one of the components of the electronic device DV described above may be included in a display device according to the non-limiting embodiments described above. Additionally, some individual modules included within a single functional module may be integrated into the display device, while others may be provided separately from the display device. For example, the display device may include the display module DM, while the processor PR, the memory MR, and the power module PM may be provided as separate devices within the electronic device DV.

FIG. 7B illustrates various electronic devices DV according to embodiments of the present disclosure.

Referring to FIG. 7B, the display module DM according to some embodiments of the present disclosure may be applied to various electronic devices DV, such as an image display electronic device including a smartphone APP1, a tablet PC APP2, a laptop computer APP3, a TV APP4, or a desktop monitor APP5. The display module DM may also be included in wearable electronic devices, such as smart glasses APP6, a head-mounted display APP7, or a smartwatch APP8. Additionally, the display module DM may be included in vehicle-mounted electronic devices APP9-APP9-4, such as a center information display CID, an instrument panel, a center fascia, a dashboard, or a rear-view mirror display.

While certain non-limiting embodiments of the present disclosure have been described above, anyone ordinarily skilled in the art to which the present disclosure pertains shall appreciate that there may be a variety of modifications and permutations of the present disclosure without departing from the technical ideas and scopes of the present disclosure. Moreover, it shall be appreciated that the described embodiments are not intended to restrict the present disclosure thereto and that every technical idea within the appended claims and their equivalents is interpreted to be included in the scope of the present disclosure.

What is claimed is:

1. An electronic device comprising:
a display module comprising a display panel emitting light, the display module having a first non-folding region, a folding region, and a second non-folding region defined therein, the folding region is disposed between the first non-folding region and the second non-folding region; and
a plate having a through-hole defined therein, the through-hole overlapping the folding region in a first direction,
wherein in a first region of the plate, a width of the through-hole in a second direction crossing the first direction varies at a first rate along the first direction, and
wherein in a second region of the plate, the width of the through-hole in the second direction varies at a second rate along the first direction, the second rate is different from the first rate.

2. The electronic device according to claim 1, wherein:
the first region is disposed between the display module and the second region; and
the first rate is less than the second rate.

3. The electronic device according to claim 2, wherein the plate comprises:
an upper surface;
a first inner surface extending from the upper surface;
a second inner surface extending from the first inner surface in a direction intersecting the first inner surface; and
a lower surface extending from the second inner surface and opposite to the upper surface,
wherein the through-hole is defined by the first inner surface and the second inner surface.

4. The electronic device according to claim 3, wherein:
the upper surface is disposed between the display panel and the lower surface in the first direction; and
wherein a surface roughness of the upper surface is less than a surface roughness of the lower surface.

5. The electronic device according to claim 3, wherein:
the first inner surface, the second inner surface, and the through-hole are each provided in plurality, and
wherein each of the plurality of through-holes is formed through a laser process and a blasting process.

6. The electronic device according to claim 5, wherein the laser process is performed prior to the blasting process.

7. The electronic device according to claim 1, further comprising:
a cover member overlapping the folding region of the plate,
wherein the plate is disposed between the display module and the cover member in the first direction.

8. The electronic device according to claim 1, further comprising a window module,
wherein the display module is disposed between the window module and the plate in the first direction.

9. The electronic device according to claim 1, wherein a first length of the first region measured in the first direction is shorter than a second length of the second region measured in the first direction.

10. An electronic device comprising:
a display module comprising a display panel emitting light, the display module having a first non-folding region, a folding region, and a second non-folding region defined therein, the folding region is disposed between the first non-folding region and the second non-folding region; and
a plate having a through-hole overlapping the folding region defined therein,
wherein the plate comprises:
an upper surface;
a first inner surface extending from the upper surface;
a second inner surface extending from the first inner surface in a direction intersecting the first inner surface; and
a lower surface extending from the second inner surface and opposite to the upper surface,
wherein the through-hole is defined by the first inner surface and the second inner surface.

11. The electronic device according to claim 10, wherein:
a first angle is formed between the upper surface and the first inner surface;
a second angle is formed between a plane including the lower surface and the second inner surface; and
a magnitude of the first angle is greater than a magnitude of the second angle.

12. The electronic device according to claim 11, wherein:
the upper surface is disposed between the display panel and the lower surface in a first direction; and
a surface roughness of the upper surface is less than a surface roughness of the lower surface.

13. The electronic device according to claim 11, wherein:
the first inner surface, the second inner surface, and the through-hole are each provided in plurality, and
wherein each of the plurality of through-holes is formed through a laser process and a blasting process.

14. The electronic device according to claim 13, wherein the laser process is performed prior to the blasting process.

15. The electronic device according to claim 10, further comprising:
a cover member overlapping the folding region of the plate in a first direction,
wherein the plate is disposed between the display module and the cover member in the first direction.

16. The electronic device according to claim 10, further comprising a window module,
wherein the display module is disposed between the window module and the plate.

17. The electronic device according to claim 10, wherein a width of the through-hole varies at a first rate over a first length in a thickness direction of the plate and varies at a second rate, different from the first rate, over a second length in the thickness direction of the plate.

18. A method for manufacturing an electronic device, the method comprising:
preparing a plate comprising an upper surface and a lower surface opposite to the upper surface;
performing a laser process, wherein a plurality of through-holes are formed in the plate through the laser process and a projection of each of the plurality of through-holes onto a plane including one of the upper surface and the lower surface has a first area;
performing a blasting process, wherein the plate is processed through the blasting process and a projection of each of the plurality of through-holes onto a plane including one of the upper surface and the lower surface has a second area larger than the first area;
preparing a display panel having a first non-folding region, a folding region, and a second non-folding region defined therein;
aligning the display panel and the plate, wherein the plurality of through-holes overlap the folding region when aligned; and
attaching the display panel to the plate.

19. The method for manufacturing an electronic device according to claim 18, wherein:
the upper surface is disposed between the lower surface and the display panel,
a surface roughness of the upper surface is less than a surface roughness of the lower surface; and
wherein in the performing of the laser process, the plurality of through-holes are formed from the lower surface towards the upper surface.

20. An electronic device comprising:
a display module comprising a display panel emitting light, the display module having a first non-folding region, a folding region, and a second non-folding region defined therein, the folding region is disposed between the first non-folding region and the second non-folding region;
a processor controlling the display module;
a memory having data necessary for operation of the display module or the processor;
a power module generating or supplying power; and
a plate having a through-hole defined therein, the through-hole overlapping the folding region in a first direction,
wherein in a first region of the plate, a width of the through-hole varies at a first rate along the first direction, and
wherein in a second region of the plate, a width of the through-hole varies at a second rate along the first direction, the second region being different from the first region, the second rate is different from the first rate.
